(19) United States
(12) Patent Application Publication
(10) Pub. No.: US 2013/0073505 A1
(43) Pub. Date: Mar. 21, 2013

(54) Methods and Framework for evaluating and modeling of contextual exchange, contextual collaboration and sensational awareness

(71) Applicant: Nick Mehrdad Loghmani, Toronto (CA)

(72) Inventor: Nick Mehrdad Loghmani, Toronto (CA)

(73) Assignee: Nick Mehrdad Loghmani, Toronto (CA)

(21) Appl. No.: 13/352,132

(22) Filed: Jan. 17, 2012

Related U.S. Application Data
(60) Provisional application No. 61/433,620, filed on Jan. 18, 2011.

(51) Int. Cl. G06N 5/02

(52) U.S. Cl. CPC G06N 5/02
USPC 706/46

(57) ABSTRACT

Methods and framework for modeling of an intelligent, contextual and sensationally aware cognition and sensory system, operating based on the principle of the harmonic theory, which herein after will be referred to as the “Harmonic System”

Harmonic Theory provides a mathematical framework to describe the structure, behavior, evolution and emergence of collaborative, contextual and sensational aware systems. A harmonic system is context aware, contains elements that manifest characteristics either collaboratively or independently according to the system's expression and can interact with its environment. The harmonic theory provides a fresh way to analyze emergence and collaboration of “ad-hoc” and complex systems.

### BACKGROUND OF THE INVENTION

The invention field is intelligent & cognitive systems and robotics

### BRIEF DESCRIPTION OF THE DRAWINGS

The foregoing and other objects, features and advantages of the invention will be apparent from the more particular description of preferred embodiments of the invention, as illustrated in the accompanying drawings in which like reference characters refer to the same parts throughout the different views. The drawings are not necessarily to scale, emphasis instead being placed upon illustrating the principles of the invention

FIG. 1 illustrates the formula to calculate the Harmonic Value.

FIG. 2 illustrates a unit circle where θ is the angle between characteristic for Hₑ and H_{c} expressed in radian as plotted on harmonic helix, in according to the present invention.

FIG. 3 illustrates the formula to calculate the harmonic significance, in accordance with the present invention.

FIG. 4 illustrates the formula to calculate the direct exchange value between two systems, in accordance with the present invention.

FIG. 5 illustrates an exemplary exchange and transformation scenario where exchange and transformation increase conformance to expression characteristics, in accordance with the present invention.

FIG. 6 illustrates an exemplary indirect exchange scenario, in accordance with the present invention.

### Harmonic System Component, Characteristics and Relation Model Explained

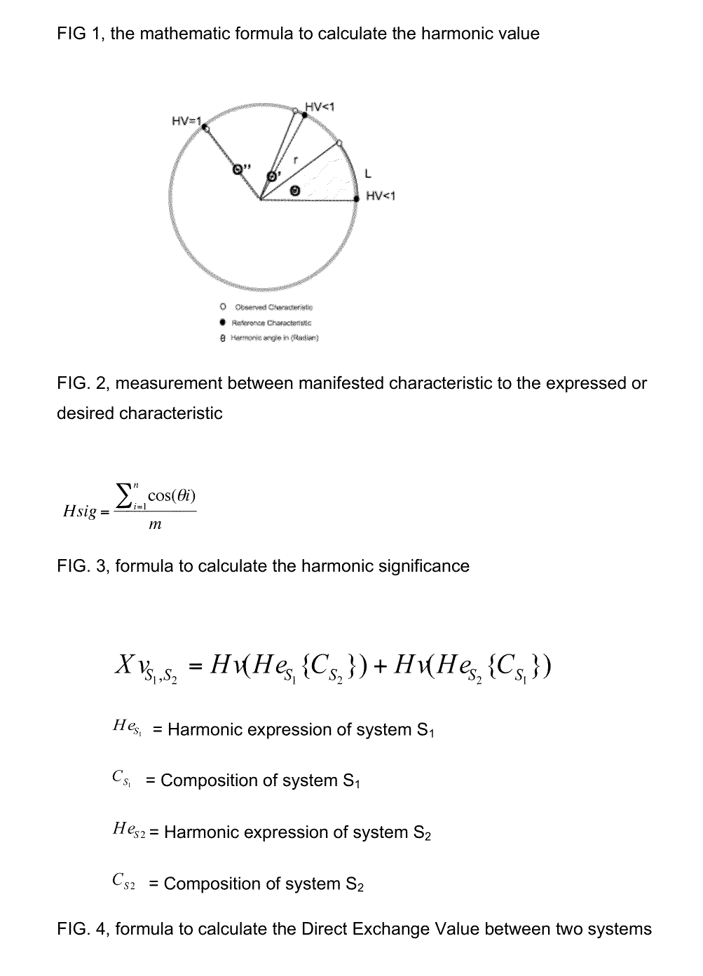

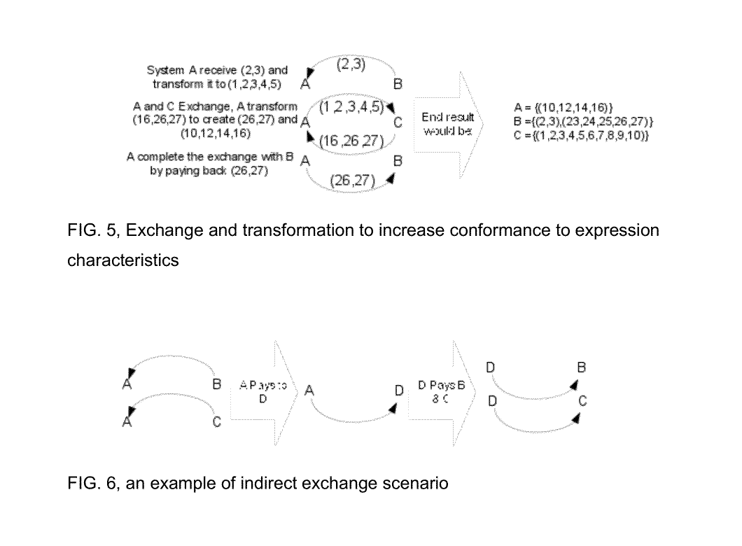

A harmonic system is defined within an environment. Environment provides the boundary for the system and resources necessary for forming and keeping compositions. The environment also acts as a medium for exchange with other systems. Environment's characteristic model influences system's expression and context as well arrangement and type of characteristics its composition's manifests. Diversity in environment's characteristic model ensures sustainability of harmonic state. Trade and exchange, along with transformation, are among the factors that influence and transform the harmonic environment.
A Harmonic system has a context. Context is the situational constraint set by the system's structure (environment, composition, expression) as well as by its action (state, evolution, transformation, exchange). Harmonic state depends on the harmonic value of compositions relative to harmonic expression. Role, granularity and arrangement of characteristics a composition manifests depend on the context it is in. By imposing patterns, restrictions and control of the domain of harmonic compositions context controls measurability and comparability of characteristic model.
A Harmonic system has a Harmonic expression. Harmonic expression creates the criteria and characteristic model based on which (in a given context) harmonic compositions can be arranged and rated.
A Harmonic system contains compositions. Composition is a pattern of entities from the harmonic environment formed to manifest a range of characteristics in accordance to expression and context.
There are three types of compositions:
   Active composition is present in the harmonic system environment and contributes to harmonic state, herein after referred to as having a harmonic relation with the harmonic expression
   Passive composition is present in the harmonic system environment but does not have a direct relation with harmonic expression. However it has a characteristic model, which is in demand by other systems. Therefore it can be used as a resource in an exchange scenario.
   Target composition is NOT present in the harmonic system environment. However, if obtained, (either through exchange with other systems, through transformation, or through a combination of both) it can boost the system's harmonic status.
As a general rule any harmonic system with a suitable characteristic model can be used as a composition in a larger system. There are two categories of characteristic model; referential or intrinsic; intrinsic characteristic are those which stem from composition's structure and natural makeup, for instance water molecular characteristic model is H2O, referential characteristics are those which are observed or infer by a third party system and as such are subjective and relative to composition real characteristic properties, for instance “Water” is the referential characteristic of H2O in the context of English language.
Characteristics role can be classified as:
Inhibitor: reduces the harmonic value of specific characteristics by suppressing or compensating their manifestation to reduce system risk (if characteristics are risk factors) or promotes a competing characteristics. Inhibitors play an important role, as they limit the scope of available options and allow the system to focus its resources
Activator: increases the harmonic state by directly conforming to harmonic expression. A pattern of characteristics is activator of a certain harmonic pattern if its conformance to the harmonic expression causes the expansion of the latter.
Facilitator: increases the harmonic state indirectly by enhancing and amplifying contributing characteristics
System components, including environment, context, expression and composition, all have “Abstract Characteristic Models”. A Characteristic Model is the derivative of the underlying subject (environment, context, composition or expression). As mentioned earlier, depending on the context, a characteristic model represents either the stable or dynamic aspect of the underlying subject. The evolution and transformation of a subject influence its characteristics.
Harmonic value provides a method to compare a manifested characteristic to the expressed or desired characteristic; Harmonic value is calculated by comparing the characteristics of H_{c} and Hₑ as represented on the Harmonic helix by c₁ to cₙ and e₁ to eₙ respectively; where L_{obs}=measure of comparison, is the observed difference between two characteristics and Lₜ=measure of comparison, is the true difference in a given context between two characteristic as measured on an intertwined double helix where:
   θ is the angle between observed and reference characteristic
   μ is the magnitude of observed characteristic measured by its deference from reference characteristic divided by π
   Its radius is 1 (for simplicity for single context can be represented by a unit circle)
   r is the distance of observation (radius of comparison circle); for the unit circle r=1
Harmonic value is calculated using the formula in FIG. 1
FIG. 2 illustrates a unit circle where θ is the angle between characteristic for Hₑ and H_{c} expressed in radian as plotted on harmonic helix, with −1 and 1 representing the min and maximum of the Hᵥ, and n is the quantity of characteristics for H_{c}, if θ=0 then characteristic has harmonic value of 1.
The underlying subject significance is highlighted by its Harmonic Significance. Harmonic Significance is the weighted harmonic value
FIG. 3 illustrates the formula to calculate harmonic significance, where m represents the total number of characteristics belonging to all compositions participating in the expression characteristic model Depending on the context, expression can have multiple characteristic model.
Harmonic Significance indicates the harmonic composition potential for contributing to the harmonic state. Significance is represented by the granularity of composition characteristics, with more significant compositions represented by a higher number of characteristics. In a given context if multiple compositions have equal or close harmonic value, harmonic significance become a deciding factor for composition selection.
Significance increases when the granularity of ‘expression characteristics’ and conforming ‘composition characteristics’ increases, Increasing granularity of characteristic for expression and composition is called enrichment; Significance decreases when the granularity of ‘expression characteristics’ decreases, Decreasing granularity of characteristic for expression and composition is called simplification.
Harmonic state represents the quadratic mean (RMS) of harmonic values of the selected compositions (selected based on their significant) in a given context.
Compositions with higher significance have more positive influence on harmonic state.
Change in the composition characteristics model can increase or decrease the harmonic significance, therefore changing the system's state. Change in the system's environment can also force a state transition by changing context and compositions.
The response of a Harmonic system to state transition can be classified as:
   Reactive; system responds to change reactively, after state transition has been detected, either by enriching composition characteristics, to conform to the enriched expression model, or simplifying the expression model, to conform to the simplified composition model.
   Active; system tries to maintain or achieve a sustainable harmonic state by creating opportunities and avoiding risks preemptively, through enrichment, simplification, exchange or a combination of all three. Active systems retain transformation patterns, which can be reused in similar contexts and subsequently can be replicated in successive evolution, therefore forming a generational memory.
Harmonic Status (HS): represents the average of harmonic values of all participating compositions over an interval [a,b] where ‘a’ and ‘b’ represent evolution boundaries.
Harmonic Exchange Value (Xᵥ); harmonic exchange value is the total “value realized” by exchanges between systems and depends on the harmonic value realized by each system, divided by the number of exchanging parties. Direct Exchange Value between two systems (S₁ and S₂) is calculated by the formula depicted in FIG. 4
Exchange efficiency is exchange value divided by number of exchanging parties in the exchange chain.
The exchange motivation factor is the difference between harmonic state before and after the exchange.
Longer exchange chains can provide potential value otherwise not attainable in direct exchange. For instance in the following exchange scenario:
Set A contain: {(10,12,14),(1,4,5)}
Set B contain: {(2,3),(23,24,25)}
Set C contain: {(6,7,8,9,10),(16,26,27)}
As illustrated in FIG. 5, Exchange and transformation to increase conformance to expression characteristics
System A transforms composition to create an exchange opportunity with B and C, System A is able to acquire composition from B by differing its payment after trading with C; the above example is a multi party exchange scenario which involve more than two exchange parties; the length of the exchange chain depends on capability of participating systems to transform and create desirable compositions for further trade and exchange.
Indirect exchange value is when payout to one party in the exchange is done through a third party (indirectly) as illustrated in FIG. 6
An example of the above scenario is the natural recycling process, where composition used by plants and animals is recycled, thus creating a Self-sufficient exchange ecosystem where exchange chain is self-sustaining.
Harmonic Transformation; is change in the characteristics of composition, environment, context or expression to maintain or increase harmonic state, status and exchangeability; there are two types of Harmonic transformation:
   Simplification:
      Simplifying the underlying subject OR
      Reducing granularity of the characteristics model OR
      A combination of both
   Decomposing a composition to create tradable compositions is an example of simplification.
   Enrichment:
      Increasing granularity of the characteristic model
      Enriching the underlying subject and creating potential for increasing granularity of the characteristic model
   Combining compositions to create a tradable characteristic model is an example of Enrichment
Positive transformation patterns emerge when:
For Context C₁ and Expression E₁ transforming the underlying subject or the characteristic model always results in harmonic state being maintained or improved. In other words:
If composition A is exchanged with, or transformed to composition B,
OR
If characteristic model X₁ is transformed to X₂
THEN ALWAYS
Harmonic state S₁ is maintained or improved.

### How Recognition Happens, Harmonic System Sensory Apparatus

Based on harmonic theory principles and in order to focus on desired characteristics and eliminate noise, sensory system is closely being influenced by the context; this process is called sensory system priming.

Harmonic context determines pattern stub, which act as a primer for the sensory system. Harmonic expansion of stub happens when a close enough observed pattern is detected (conformity is evaluated using harmonic value formula); harmonic expansion triggers further cycle of priming and observing. Optimum cycle frequency is calculated by dividing subject characteristics (represented by observable patterns) divided by quadratic mean of cognition system available capacity (represented by primed pattern stub) and sensory system capability (represented by observed pattern), rounded to next whole number.

Optimum frequency is achieved when both cognition system capacity and sensory system capability converge to quadratic mean.

Cycle's frequency can be further optimized by reducing granularity of subject characteristic model (simplification), or by increasing primed & observed patterns (capacity of cognitive and sensory system).

Context has a great influence on priming the sensory system with patterns to look for and selection of patterns to expand.

### Thinking

Thinking is the ability to use referential characteristics to create scenarios to transform, rearrange and combine various characteristic patterns in order to facilitates emergence of new expression and composition; it also entails evaluating harmonic value and composition arrangement in various context scenarios. This process creates the possibility to observe collaborative emergence of expression and discover cause and effect.

### Imagination

Imagination is the ability to virtualize sensory system to simulate and invoke referential characteristics (patterns) “as if they were observed” to trigger detection and expansion of stub patterns; in other word, arranging patterns and priming them in virtualized sensory system to create real or virtual (imaginative) response.

### Creativity

Creativity is systemic use of referential characteristic, virtualization and transformation to increase efficiency (by reducing cycles) and number of desirable characteristics (through arrangement of composition) as well as the ability to permute and combine compositions to facilitate emergence of new expressions and systems and observe and memorize the process.

### Instincts and “Need”

Instinct expressions are major contributor to the harmonic system's health and harmonic status, they are required to maintain the integrity, health and continuity of the system, harmonic status that stem from instincts acts as a motivator to maintain and increase compositions which are required to satisfy instinctive expressions (by manifesting conforming characteristics).

### Sensory System and Consciousness

Harmonic System sensory system captures information on its own term, cognitive system primes sensory system for “familiar” or pattern of “interest”. Sensory system transmits information as “harmonic patterns” (which are “referential” characteristics); ability to observe and memorize these patterns constitutes “sensational familiarity”. Sensational familiarity is system's ability to observe, memorize and prime (reproduce) referential characteristics experienced by its sensory apparatus. Sensational familiarity in conjunction with cognitive system ability to project referential characteristics of sensory system in “virtualized sensory” is the bases for awareness and self-image.

### Harmonic System Self Awareness and Vision of Self (Personality)

“Self” is a Cluster of virtual compositions based on referential and intrinsic characteristics, which exhibits characteristics pattern and traits according to virtual or real scenario. Referential and intrinsic characteristics are the result of sensory and cognitive system operation and interactions, referential characteristic help forming a composition with intrinsic characteristics. Creating a Scenario is done by priming the virtual sensory with stub pattern to trigger a response from cognitive system. Awareness of “Self” as a construct, stems from the ability to observe and predict manifestation of characteristics according to stimulus (either virtual or real). Development of self is vital for simulation and imagination, through which system can create and rate permutation of various scenarios to increase efficiency and reduce risk.

### Social Behavior

Social interactions arise from the need to enrich available compositions in the environment, enhance exchange opportunities and increase efficiency by specialization. Collaboration and social interaction aids emergence of new opportunities and reduce risk through collaboration to cause emergence of characteristics, which are risk inhibitors. Harmonic exchange requires a collaborative and cooperative environment where new composition arrangements would lead to increase opportunity for all of its participants.

### Belief, Value System and Morality

Risk mitigation, increased social & environmental interaction and exchange opportunities are among the driving forces to form Harmonic system belief and value system, which is key and influential in its governance. Beliefs and value system comprise of cluster of virtual compositions; which are formed based on observed (or inferred) intrinsic characteristics when manifested by external or internal compositions. For example socialization increases the odd of survival and increase exchange opportunities; therefore intrinsic characteristic of socialization contributes to forming system's value & belief composition. Intrinsic characteristics based on values and beliefs are strong contributors to harmonic status as they influence the decision to pursuit and expand a pattern stub; if pursuit of pattern causes reduced harmonic value for “values and beliefs” characteristics, harmonic status declines substantially where degree of decline depends on granularity of “Values and Beliefs” system characteristics and granularity and significance of opportunity pattern.

### Emotions

Emotions are intrinsic characteristic comprising of sensational and cognitive patterns expressed by instinctive compositions. Demonstration of characteristics by Instinctive compositions depends on context, environment, and observation or detection of (a particular) arrangement of characteristics. When manifested, instinctive composition characteristics can lead to expansion of harmonic patterns, expression of referential characteristics (that can be inferred as emotional response) or transformation of context and environment characteristic pattern (which is more subtle).

Change in harmonic state, (which itself is governed by intrinsic and referential characteristic conformity to an expressed harmonic expression) can act as a trigger for expression of emotional pattern. There is a correlation between characteristic pattern, its context and type of emotion; for instance an act which is at odd with characteristic pattern of “morality” creates a significant delta in harmonic value, therefore causes expression of characteristics pattern which is associated with “guilt”. Context plays a role in type of emotion that are expressed and experienced by transforming the granularity of expression pattern sensitive to emotional characteristic pattern, or manipulating/changing the response pattern.

### Reason

Logical relation model defines the arrangement, sequence, relation and role of characteristics (characteristic role can be as “expansion activator”, “facilitator” or “inhibitor”) according to a reference patterns constructed from characteristics manifested by intrinsic or virtual compositions. Reason is based on the ability to observe the logical relation of patterns and construct a referential logical relation model accordingly.

### Rationality

Reason is the ability to infer causality based on observation and construction of the referential logical relation model; rationality is the ability to optimize the relation model and system response cycles according to the context. Rationality involves examining relationship of different patterns (characteristic models) from causality perspective in different context (simulating scenarios). It also involves using simulation, observation and transformation to create elaborate permutation of expansion scenarios as well as to optimize granularity of the response pattern for the given context.

### Language

Spoken language is based on series of auditory patterns; consisting of sound characteristic, expressed and observed by the auditory system to form a referential characteristic model to represent familiar sensation or cognitive patterns. Written symbols (characters, words) are referential characteristics based on further abstraction of the auditory patterns.

1- A method of evaluating a conformance of the characteristics manifested by a set of compositions according to a expressed criteria and characteristic model set by a system, the method comprising:
determining conformance of the manifested characteristics against the expressed criteria and characteristic model; evaluating different transformation and arrangement of the compositions and their characteristics to yield better conformance to the expressed criteria and characteristic model; evaluating exchange of the compositions with other systems.

2- The method of claim 1, further comprising: detecting, observing, memorizing and reproducing referential characteristics manifested by the compositions in the environment, constructing relational logical model of the characteristics and develop a virtual composition capable of manifesting characteristics according to the context and system's state.

3- The method of claim 1, further comprising: developing virtual awareness through constructing virtual compositions based on the referential characteristics deriving from the compositions of the system or external observed compositions.

4- The method of claim 1 wherein the system participates in exchange with other systems to exchange compositions, in order to receive a composition or compositions, the method further comprising: evaluating the exchange value by measuring the conformance of the characteristics of the candidate composition to the system's criteria and characteristic model.

5- The method claim 1, further comprising: simulating virtual scenarios based on modifying the existing referential characteristics or creating new referential characteristics to reduce risk and create new characteristic permutation and arrangements.

6- The method claim 1, further comprising: rearranging and transforming characteristics of the system's environment, context, composition or expression in order to reduce the difference between the expressed and measured characteristics.

7- The method of claim 1 wherein the system communicates using abstract symbolized referential characteristics that are agreed upon through exchange with third parties.

8- Sensory systems comprising but not limited to auditory, visual and tactile systems where its sensors translate signals into referential characteristics.

9- System of claim 8 wherein the expression characteristics model increases the sensory system sensitiveness to identify conforming referential characteristics, causing the sensory system to translates signals into referential characteristics based on the primed expression.

10- A method of storing wherein the referential characteristics of a composition is stored in relation to the system's expression characteristics model and context characteristics model.

11- The method of claim 10 wherein the storage system stores referential characteristics based on the expression characteristics model and can be stimulated by the expression characteristics model and the context characteristics model to amplify and retrieve the stored characteristics pattern.

12- System of claim 10 wherein retrieved characteristics result in sensory or motor function.
